(19) United States
(12) Patent Application Publication
(10) Pub. No.: US 2019/0107943 A1
(43) Pub. Date: Apr. 11, 2019

(54) ELECTRONIC DEVICE, CONTROL DEVICE, AND METHOD FOR CONTROLLING ELECTRONIC DEVICE

(71) Applicant: SHARP KABUSHIKI KAISHA, Sakai City (JP)

(72) Inventors: SHUJI DAIOKU, Sakai City (JP); NOZOMU NISHIMOTO, Sakai City (JP); KOHSEI KAWAMOTO, Sakai City (JP); MUNETAKA YASUNOU, Sakai City (JP)

(21) Appl. No.: 16/155,627

(22) Filed: Oct. 9, 2018

(30) Foreign Application Priority Data
Oct. 10, 2017 (JP) 2017-197270

(51) Int. Cl. G06F 3/0488; G06F 3/0484; G06F 3/147; G06F 3/046

(52) U.S. Cl. CPC G06F 3/04883; G06F 3/046; G06F 3/1475; G06F 3/04845

(57) ABSTRACT

Display modes are switched by a simple method in accordance with whether or not to display status information. An electronic device (1) includes a control section (20) which (i) causes status information (ST1 to ST4) of the electronic device to be displayed in at least either (a) an enlarged display mode in which to display the status information in a first display region (D1) or (b) an alternative display mode in which to display the status information in a second display region (D2) and causes a switchover accepting display (SW1) for accepting a switchover from the alternative display mode to the enlarged display mode to be displayed in the first display region.

This Nonprovisional application claims priority under 35 U.S.C. § 119 on Patent Application No. 2017-197270 filed in Japan on Oct. 10, 2017, the entire contents of which are hereby incorporated by reference.

### TECHNICAL FIELD

The present invention relates to an electronic device, a control device, a method for controlling an electronic device, and a control program.

### BACKGROUND ART

Non-Patent Literature 1 discloses an electronic device whose display surface has a notch part at a center of an upper part thereof and which has a display region in which to display, on either side of the notch part, status information such as time or a remaining battery level.

### CITATION LIST

### Non-Patent Literature

[Non-Patent Literature 1]

REVIEW: The Essential Phone is a superb smartphone, [online], Aug. 23, 2017, [searched on Sep. 25, 2017], Internet <URL:http://www.businessinsider.com/review-the-essential-phone-is-a-superb-smartphone-2017-8/# some-thoughts-on-the-notch-2>

### SUMMARY OF INVENTION

### Technical Problem

Note, however, that according to the electronic device disclosed in the above Non-patent Literature, an application or the like that is designed to display no status information is not assumed to be activated. Thus, the above electronic device in which an application or the like that is designed to display no status information is activated unfortunately makes it impossible to clearly display an image on the display surface.

Furthermore, the above Non-patent Literature fails to disclose how to change display modes in accordance with whether or not to display the status information.

An aspect of the present invention has an object to switch display modes by a simple method in accordance with whether or not to display status information.

### Solution to Problem

In order to attain the object, an electronic device in accordance with an aspect of the present invention includes: an input section configured to detect an input carried out by a user; a display section at least a part of which is provided with a notch part; and a control section, the control section providing the display section with a first display region in which the notch part is provided and a second display region which is a display region different from the first display region, the control section causing the display section to carry out a display process in at least either of the following two display modes: an enlarged display mode in which to display status information of the electronic device in the first display region and to use the second display region as a region in which to show details of an application; and an alternative display mode in which to display no status information of the electronic device in the first display region and to display the status information of the electronic device in the second display region, and the control section causing a switchover accepting display for accepting a switchover from the alternative display mode to the enlarged display mode to he displayed in the first display region through the input from the input section.

A control device in accordance with an aspect of the present invention includes: an input section configured to detect an input carried out by a user; a display section at least a part of which is provided. with a notch part; a display control section; and a mode determining section, the display control section providing the display section with a first display region in which the notch part is provided and a second display region which is a display region different from the first display region, the display control section causing a display process to be carried out on a display surface of the display section in at least either of the following two display modes: an enlarged display mode in which to display status information of the control device in the first display region and to use the second display region as a region in which to show details of an application; and an alternative display mode in which to display no status information of the control device in the first display region and to display the status information of the control device in the second display region, the display control section causing a switchover accepting display for accepting a switchover from the alternative display mode to the enlarged display mode to be displayed in the first display region through the input from the input section, and the mode determining section determining at least either of the two display modes, which are the enlarged display mode and the alternative display mode, and then supplying a result of the determination to the display control section.

A method in accordance with an aspect of the present invention for controlling an electronic device including a display section at least a part of which is provided with a notch part, the method includes: a first step of providing a display surface of the display section with a first display region in which the notch part is provided and a second display region which is a display region different from the first display region; and a second step of causing the display section to carry out a display process in at least either of the following two display modes: an enlarged display mode in which to display status information of the electronic device in the first display region and to use the second display region as a region in which to show details of an application; and an alternative display mode in which to display no status information of the electronic device in the first display region and to display the status information of the electronic device in the second display region, in the second step, a switchover accepting display being displayed in the first display region through an input carried out by a user, the switchover accepting display being a display for accepting a switchover from the alternative display mode to the enlarged display mode.

### Advantageous Effects of Invention

An aspect of the present invention brings about an effect of switching display modes by a simple method in accordance with whether or not to display status information.

### BRIEF DESCRIPTION OF DRAWINGS

FIG. 1 has views each illustrating a display of an electronic device in accordance with Embodiment 1 of the present invention. (a) of FIG. 1 is a view illustrating a display of the electronic device in an alternative display mode in a case where no status information is displayed. (b) of FIG. 1 is a view illustrating a display of the electronic device in the alternative display mode in a case where status information is displayed.

(a) of FIG. 2 is a view illustrating a display of the electronic device of FIG. 1 in an enlarged display mode. (b) of FIG. 2 is a view illustrating a display of an electronic device in a variation of the electronic device of FIG. 1.

FIG. 3 is a block diagram illustrating a configuration of the electronic device of FIG. 1.

FIG. 4 is a flowchart showing an example of a flow of a process carried out by the electronic device of FIG. 1.

FIG. 5 has views each illustrating a transverse screen display of an electronic device in accordance with Embodiment 2 of the present invention. (a) of FIG. 5 is a view illustrating a display of the electronic device in a case where a first display region is located on the left. (b) of FIG. 5 is a view illustrating a display of the electronic device in a case where the first display region is located on the right.

(a) of FIG. 6 is a view illustrating a display of an electronic device in accordance with Embodiment 3 of the present invention in a case where no status information is displayed. (b) of FIG. 6 is a view illustrating a display of the electronic device of (a) of FIG. 6 in a case where status information is displayed.

FIG. 7 has views each illustrating a transverse screen display of the electronic device of FIG. 6. (a) of FIG. 7 is a view illustrating a display of the electronic device in a case where status information is displayed and a notch part is located on the left. (b) of FIG. 7 is a view illustrating a display of the electronic device in a case where the status information is displayed and the notch part is located on the right.

### DESCRIPTION OF EMBODIMENTS

### Embodiment 1

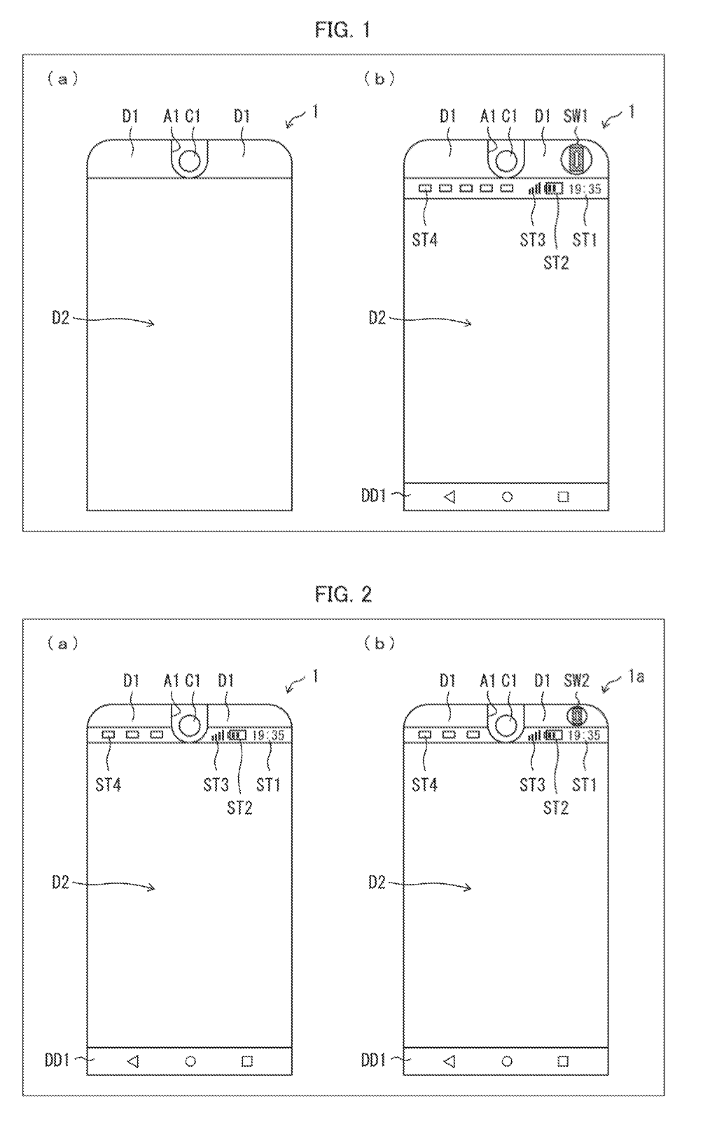

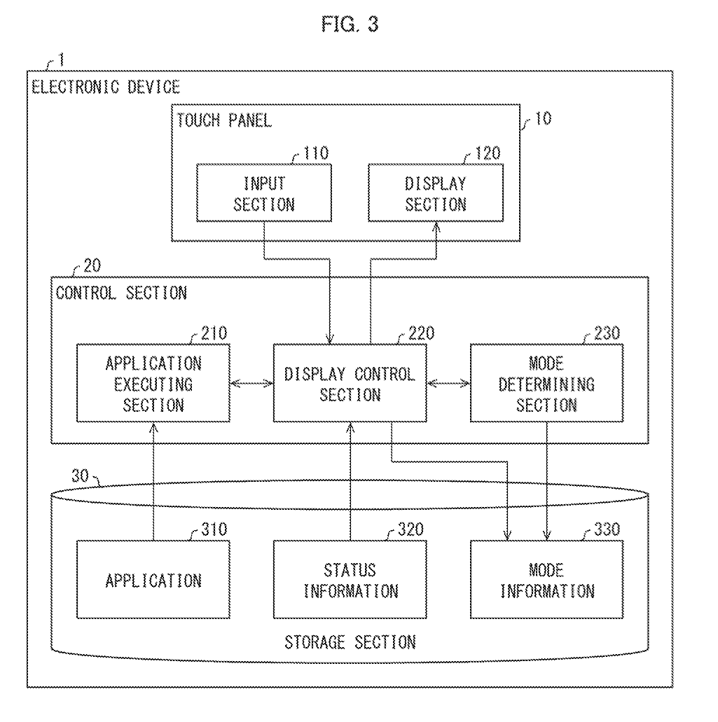

FIG. 1 has views each illustrating a display of an electronic device 1 in accordance with Embodiment 1 of the present invention. (a) of FIG. 1 is a view illustrating a display of the electronic device 1 in an alternative display mode in a case where no status information ST1 to ST4 is displayed. (b) of FIG. 1 is a view illustrating a display of the electronic device 1 in the alternative display mode in a case where status information ST1 to ST4 is displayed. (a) of FIG. 2 a view illustrating a display of the electronic device 1 in an enlarged display mode. FIG. 3 is a block diagram illustrating a configuration of the electronic device 1.

(Configuration of Electronic Device 1)

As illustrated in FIG. 3, the electronic device 1 includes a touch panel 10, a control section 20, and a storage section 30. The electronic device 1 can be, for example, a portable information terminal such as a smartphone or a tablet terminal. The touch panel 10 can be a single touch panel 10 or a plurality of touch panels 10. The storage section 30 can be a single storage section 30 or a plurality of storage sections 30. Note that a control device which includes the control section 20 and is configured to control the electronic device 1 is also encompassed in the scope of the present invention. The control device can be a single control device or a plurality of control devices.

The touch panel 10 includes an input section 110 and a display section 120. The input section 110 can include, for example, a capacitance sensor configured to detect a touch input carried out by a user. The input section 110 supplies a result of the detected touch input to a display control section 220. The display section 120 displays an image in accordance with an instruction from the display control section 220. That is, the display section 120 carries out a display process in accordance with the touch input which has been detected by the input section 110.

The control section 20 includes an application executing section 210, the display control section 220, and a mode determining section 230. The application executing section 210 executes various applications 310 which are stored in the storage section 30. In accordance with the result of the touch input which result has been supplied from the input section 110, the display control section 220 gives an instruction to each of the application executing section 210, the mode determining section 230, and the display section 120. In accordance with the instruction from the display control section 220, the mode determining section 230 determines either of two display modes, which are the enlarged display mode and the alternative display mode. Then, the mode determining section 230 supplies a result of the determination to the display control section 220. The mode determining section 230 causes the result of the determination to be stored, in a form of mode information 330, in the storage section 30. The display control section 220 provides the display section 120 with a first display region D1 and a second display region D2.

The storage section 30 stores therein the various applications 310, status information 320, and the mode information 330. The status information 320 is, for example, the status information ST1 to ST4 illustrated in (b) of FIG. 1. The status information ST1 is information indicative of current time. The status information ST2 is information indicative of a remaining battery level of the electronic device 1. The status information ST3 is information indicative of a radio field intensity. The status information ST4 is information indicative of an application 310 which is currently active. The mode information is information indicative of a display mode which is currently in use and is one of the two display modes, which are the enlarged display mode and the alternative display mode.

(Display Surface of Electronic Device 1)

The electronic device 1 has a display surface as illustrated in (a) of FIG. 1. The display surface of the electronic device 1 is rectangular and has a notch part A1 which is provided in at least a part of an outer edge of the display surface. The display surface is included in the display section 120. The display surface of the electronic device 1 has (i) the first display region D1 in which the notch part A1 is provided in at least a part of the display surface and (ii) the second display region D2 which is a display region different from the first display region D1.

The notch part A1 is provided on at least one side of the outer edge of the display surface of the electronic device 1. The first display region D1 is provided parallel to one side of the outer edge on which one side the notch part A1 is provided. This makes it possible to set the first display region D1 and the second display region D2 without causing a feeling of strangeness to the user. Furthermore, the outer edge of the display surface of the electronic device 1 has at least one corner which is arc-shaped. With the configuration, by, for example, causing the electronic device 1 to have a frame which is fit to corners of the outer edge of the display surface, the electronic device 1 can have a smaller frame while having a smaller size.

Moreover, the display surface of the electronic device 1 has a camera C1 which is provided inside the notch part A1. Note that not only the camera C1 but also, for example, a device such as a microphone, a switch, or a flashlight, or a hole through which to pass a strap can be provided inside the notch part A1. Note also that for example, a sensor device(s) such as a fingerprint sensor, an iris sensor, an ultrasonic sensor, and/or a proximity sensor can be provided inside the notch part A1.

(Flow of Process Carried Out by Electronic Device 1)

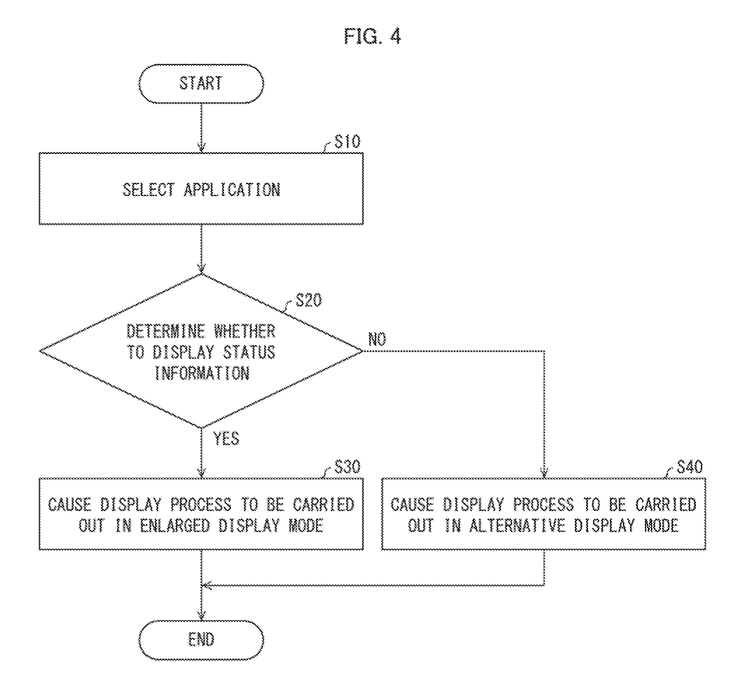

The following description discusses, with reference to FIG. 4, a process carried out by the electronic device 1 (a method for controlling the electronic device 1). FIG. 4 is a flowchart showing an example of a flow of the process carried out by the electronic device 1. Assume, for example, that the user instructs the electronic device 1, through a touch operation, to activate an application. In this case, the input section 110 detects the touch input carried out by the user, and then supplies, to the display control section 220, a result of the detection of the touch input.

The display control section 220 supplies the result of the detection of the touch input to the application executing section 210. The application executing section 210 to which the result of the detection of the touch input has been supplied from the display control section 220 selects, out of the applications 310 which are stored in the storage section 30, an application 310 which is in accordance with the result of the detection of the touch input (a step S10).

The application executing section 210 instructs the display control section 220 to activate the application 310 which the application executing section 210 has selected. The display control section 220 supplies, to the mode determining section 230, information on the application 310 which has been selected by the application executing section 210. The mode determining section 230 determines, with reference to the information on the application 310 which information has been supplied from the display control section 220, whether to display the status information ST1 to ST4 (a step S20).

(Enlarged Display Mode)

In a case where the status information ST1 to ST4 is displayed during activation of the application 310 (in the case of YES in the step S20), the mode determining section 230 determines that a display process will be carried out in the enlarged display mode. The mode determining section 230 causes the mode information 330 that the display process will be carried out in the enlarged display mode to be stored in the storage section 30. The mode determining section 230 instructs the display control section 220 that the display process should be carried out in the enlarged display mode. By controlling the display section 120 so that the display process is carried out in the enlarged display mode, the display control section 220 causes the display process to be carried out in the enlarged display mode (a step S30, which is a step of causing the display process to be carried out on the display surface, or a second step). The display control section 220 which causes the display process to be carried out in the enlarged display mode provides the display section 120 with the first display region D1 and the second display region D2 (a step of providing the first display region and the second display region, or a first step).

Note that in the case of a vertical screen display in the enlarged display mode, the display control section 220 causes the status information ST1 to ST4 which is displayed in the first display region D1 to be displayed separately in a plurality of regions in accordance with details of the status information ST1 to ST4. In (a) of FIG. 2, the display control section 220 (i) causes the status information ST1 to ST3 to be displayed in a region located on the right side of the notch part A1 and (ii) causes the status information ST4 to be displayed in a region located on the left side of the notch part A1.

(a) of FIG. 2 illustrates a display of the electronic device 1 in a case where the display control section 220 carries out the display process in the enlarged display mode. As illustrated in (a) of FIG. 2, in the enlarged display mode, the status information ST1 to ST4 of the electronic device 1 is displayed in the first display region D1, and the second display region D2 is used as a region in which to show details of an application.

Specifically, in the enlarged display mode, the display control section 220 (i) causes the status information ST1 to ST4 to be displayed in at least a part of the first display region D1 and (ii) causes the details of the application to be displayed in the second display region D2. In the enlarged display mode, fewer pieces of the status information ST4 can be displayed than in the alternative display mode. This is because a space in which to display the status information ST4 is made smaller due to a space for the notch part A1. The display control section 220 can alternatively be configured to, while causing the status information ST1 to ST4 to be displayed in the first display region D1, cause an operation button display DD1 to be displayed in the first display region D1.

(Alternative Display Mode)

In a case where no status information ST1 to ST4 is displayed during activation of the application 310 (in the case of NO in the step S20), the mode determining section 230 determines that the display process will be carried out in the alternative display mode. The mode determining section 230 causes the mode information 330 that the display process will be carried out in the alternative display mode to be stored in the storage section 30. The mode determining section 230 instructs the display control section 220 that the display process should be carried out in the alternative display mode. By controlling the display section 120 so that the display process is carried out in the alternative display mode, the display control section 220 causes the display process to be carried out in the alternative display mode (a step S40, which is the step of causing the display process to be carried out on the display surface, or the second step). The display control section 220 which causes the display process to be carried out in the alternative display mode provides the display section 120 with the first display region D1 and the second display region D2 (the step of providing the first display region and the second display region, or the first step).

(a) of FIG. 1 illustrates a display of the electronic device 1 in a case where the display control section 220 causes the display process to be carried out in the alternative display mode. As illustrated in (a) of FIG. 1, display control section 220 (i) prevents the status information ST1 to ST4 from being displayed in the first display region D1 and (ii) causes details of an application to be displayed in the second display region D2. Thus, in the alternative display mode, no status information ST1 to ST4 is displayed in the first display region D1.

Note that in order to cause the status information ST1 to ST4 to be displayed while the display process is being carried out in the alternative display mode, the control section 20 causes the status information ST1 to ST4 to be displayed in the second display region D2. This is specifically described below. Assume that the status information ST1 to ST4 is displayed on the display surface by operation of the application while the display process is being carried out in the alternative display mode. In this case, by, for example, controlling the display section 120 so as to display the status information ST1 to ST4 in an upper part of the second display region D2, the display control section 220 causes the status information ST1 to ST4 to be displayed in the upper part of the second display region D2.

(b) of FIG. 1 illustrates a display of the electronic device 1 in a case where the status information ST1 to ST4 is displayed in the upper part of the second display region D2. Note that in order to cause the status information ST1 to ST4 to be displayed in the second display region D2, the display control section 220 causes a switchover accepting display SW1 for accepting a switchover from the alternative display mode to the enlarged display mode to be displayed in the first display region D1 through the touch input from the input section 110.

In other words, in a case where the status information ST1 to ST4 is being displayed in the alternative display mode, the display control section 220 causes the switchover accepting display SW1 to be displayed. This allows the switchover from the alternative display mode to the enlarged display mode in a case where the status information ST1 to ST4 is being displayed in the alternative display mode.

As illustrated in (b) of FIG. 1, the display control section 220 can be configured to, while causing the status information ST1 to ST4 to be displayed in the upper part of the second display region D2, cause the switchover accepting display SW1 for accepting the switchover from the alternative display mode to the enlarged display mode to be displayed in the first display region D1. The display control section 220 can alternatively be configured to, while causing the status information ST1 to ST4 to be displayed in the second display region D2, cause the operation button display DD1 to be displayed in the first display region D1.

A touch of the switchover accepting display SW1 by the user causes the switchover from the alternative display mode to the enlarged display mode. Specifically, the touch of the switchover accepting display SW1 by the user causes the input section 110 to detect the touch input carried out by the user, and then supply, to the display control section 220, a result of the detection of the touch input. In accordance with the result of the detection of the touch input, the display control section 220 controls the display section 120 so that the display process is carried out in the enlarged display mode. Furthermore, the display control section 220 causes the mode information 330 that the display process will be carried out in the enlarged display mode to be stored in the storage section 30.

The control section 20 thus causes the display process to be carried out on the display surface in either of (i) the enlarged display mode in which to display the status information ST1 to ST4 in the first display region D1 and (ii) the alternative display mode in which to display no status information ST1 to ST4 in the first display region D1. With the configuration, in a case where the status information ST1 to ST4 is displayed, the status information ST1 to ST4 can be displayed in the first display region D1. This makes it possible to use, as a region in which to show details of an application or the like, the entire second display region D2 which is unaffected by the notch part A1. Furthermore, even in a case where an application or the like that is designed to display no status information ST1 to ST4 is activated, it is possible to display the status information ST1 to ST4, without reducing a region in which to show details of the application or the like, while clearly displaying an image on the display surface.

In order to cause the status information ST1 to ST4 to be displayed during activation of an application, the control section 20 causes the display process to be carried out in the enlarged display mode. Meanwhile, in order to cause no status information ST1 to ST4 to be displayed during activation of the application, the control section 20 causes the display process to be carried out in the alternative display mode. This makes it possible to display the status information ST1 to ST4 without reducing a region in which to show details of the application.

In order to cause the status information ST1 to ST4 to be displayed. while the display process is being carried out in the alternative display mode, the control section 20 causes the status information ST1 to ST4 to be displayed in the second display region D2. This makes it possible to suitably display the status information. ST1 to ST4 also in the alternative display mode.

Furthermore, in order to cause the status information ST1 to ST4 to be displayed in the second display region D2, the control section 20 causes the switchover accepting display SW1 for accepting the switchover from the alternative display mode to the enlarged display mode to be displayed in the first display region D1. This allows a switchover to a display of the status information ST1 to ST4 in the first display region D1 during the display of the status information ST1 to ST4 in the second display region D2. This also allows a change from a state in which a region in which to show details of an application or the like is made narrow due to the status information ST1 to ST4 which is being displayed in the second display region D2 to a state in which, while the status information ST1 to ST4 is being displayed, the entire second display region D2 is used as the region in which to show details of an application or the like. Thus, the display modes can be switched by a simple method in accordance with whether or not to display the status information ST1 to ST4.

(Variation)

(b) of FIG. 2 is a view illustrating a display of an electronic device 1a, which is a variation of the electronic device 1. The electronic device 1a differs from the electronic device 1 in that the electronic device 1a is configured such that a switchover accepting display SW2, different from the switchover accepting display SW1, for accepting a switchover from the enlarged display mode to the alternative display mode is displayed in a first display region D1. According to the electronic device 1a, the switchover accepting display SW2 is displayed in the first display region D1 during process of the step S30. This is specifically described below.

During the process of the step S30, a display control section 220 causes the switchover accepting display SW2 to be displayed in the first display region D1. A touch of the switchover accepting display SW2 by a user causes a switchover from an enlarged display mode to an alternative display mode. Specifically, the touch of the switchover accepting display SW2 by the user causes an input section 110 to detect a touch input carried out by the user, and then supply, to the display control section 220, a result of the detection of the touch input. In accordance with the result of the detection of the touch input, the display control section 220 controls a display section 120 so that a display process is carried out in the alternative display mode. Furthermore, the display control section 220 causes mode information 330 that the display process will be carried out in the alternative display mode to be stored in a storage section 30.

### Embodiment 2

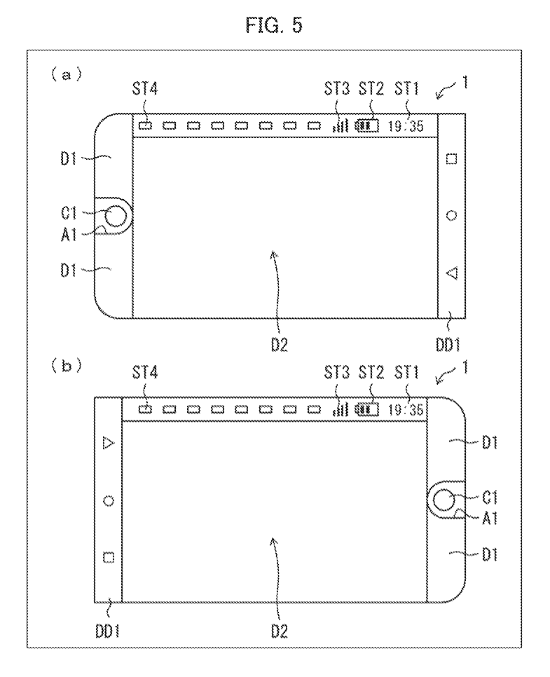

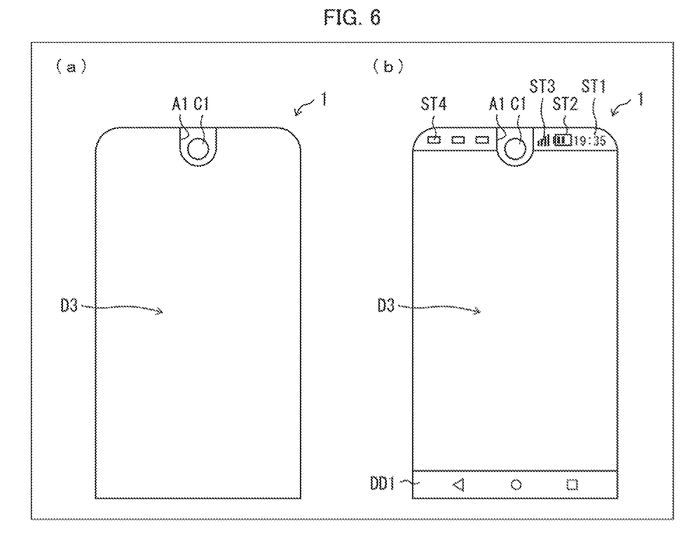

FIG. 5 has views each illustrating a transverse screen display of an electronic device 1 in accordance with Embodiment 2 of the present invention. (a) of FIG. 5 is a view illustrating a display of the electronic device 1 in a case where a first display region D1 is located on the left. (b) of FIG. 5 is a view illustrating a display of the electronic device 1 in a case where the first display region D1 is located on the right. Note that, for convenience, members having functions identical to those of the respective members described in Embodiment 1 are given respective identical reference signs, and a description of those members is omitted here.

A control section 20 which has caused a change from a vertical screen display to a transverse screen display in an enlarged display mode switches the enlarged display mode to an alternative display mode so that a display process is carried out in the alternative display mode. This is specifically described below. Assume that, in a state of the vertical screen display in the enlarged display mode, the electronic device 1 is instructed, through a touch operation carried out by a user, to carry out the transverse screen display. In this case, an input section 110 detects a touch input carried out by the user, and then supplies, to a display control section 220, a result of the detection of the touch input.

In accordance with the result of the detection of the touch input, the display control section 220 controls a display section 120 so as to cause the change from the vertical screen display to the transverse screen display. Note that in the case of the transverse screen display, the display control section 220 switches the enlarged display mode to the alternative display mode and causes status information ST1 to ST4 to be displayed in a single region without being displayed separately in a plurality of regions.

Note also that in the case of the transverse screen display, the display control section 220 causes nothing to be displayed in the first display region D1. The first display region D1 in the transverse screen display is less easily visually recognizable to the user. Thus, even in a case where some information is displayed in the first display region D1, it may be impossible for the user to recognize that information. In the case of the transverse screen display, since nothing is displayed in the first display region D1, it is possible to prevent or reduce a wasteful display of information.

(a) or (b) of FIG. 5 illustrates a display of the electronic device 1 in a case where the display control section 220 controls the display section 120 so as to cause the change from the vertical screen display to the transverse screen display. For example, as illustrated in (a) of FIG. 5, in a case where the first display region D1 is located on the left, the display control section 220 can cause the status information ST1 to ST4 to be displayed in a side part (on an upper side) of a second display region D2. Meanwhile, as illustrated in (b) of FIG. 5, in a case where the first display region D1 is located on the right, the display control section 220 can cause the status information ST1 to ST4 to be displayed in the side part (on the upper side) of the second display region D2.

The control section 20 which has caused the change from the vertical screen display to the transverse screen display in the enlarged display mode thus switches the enlarged display mode to the alternative display mode so that the display process is carried out in the alternative display mode. With the configuration, the display process can be carried out in the alternative display mode during the transverse screen display. This allows the status information ST1 to ST4 to be displayed in the second display region D2, and consequently allows the status information ST1 to ST4 to be easily recognizable to the user.

Note that in the case of the vertical screen display in the enlarged display mode, the control section 20 causes the status information ST1 to ST4 which is displayed in the first display region D1 to be displayed separately in a plurality of regions in accordance with details of the status information ST1 to ST4. In the case of the transverse screen display, the control section 20 switches the enlarged display mode to the alternative display mode and causes the status information ST1 to ST4 to be displayed in a single region without being displayed separately in a plurality of regions. With the configuration, the status information ST1 to ST4 is displayed. in a single region in the case of the transverse screen display which allows a transversely long use of a screen of the electronic device 1, whereas the status information ST1 to ST4 is displayed separately in a plurality of regions in the case of the vertical screen display which prevents the transversely long use of the screen of the electronic device 1. This allows notification information to be suitably displayed in accordance with a length of a usable region of the screen of the electronic device 1.

### Embodiment 3

(a) of FIG. 6 is a view illustrating a display of an electronic device 1 in accordance with Embodiment 3 of the present invention in a case where no status information ST1 to ST4 is displayed. (b) of FIG. 6 is a view illustrating a display of the electronic device 1 of (a) of FIG. 6 in a case where status information ST1 to ST4 is displayed. Note that, for convenience, members having functions identical to those of the respective members described in Embodiments 1 and 2 are given respective identical reference signs, and a description of those members is omitted here.

As illustrated in (a) of FIG. 6, the electronic device 1 has a display surface which has a notch part A1 and includes a third display region D3. That is, an entire display region of the display surface of the electronic device 1 is the third display region D3. Assume, for example, that a user instructs the electronic device 1, through a touch operation, to activate an application. In this case, after a process of the step S10 (described earlier) is carried out, an application executing section 210 instructs a display control section 220 to activate an application 310 which the application executing section 210 has selected.

The display control section 220 supplies, to a mode determining section 230, information on the application 310 which has been selected by the application executing section 210. The mode determining section 230 determines, with reference to the information on the application 310 which information has been supplied from the display control section 220, whether the application 310 is a specific application. The specific application refers to an application that is stored in a storage section 30 in advance and designed to carry out a display process in a full-screen display mode during activation of the application.

(Full-Screen Display Mode)

In a case where the application 310 is a specific application during activation of the application 310, the mode determining section 230 determines that the display process will be carried out in the full-screen display mode. The mode determining section 230 causes mode information 330 that the display process will be carried out in the full-screen display mode to be stored in the storage section 30. The mode determining section 230 instructs the display control section 220 that the display process should be carried out in the full-screen display mode. By controlling a display section 120 so that the display process is carried out in the full-screen display mode, the display control section 220 causes the display process to be carried out in the full-screen display mode.

Note that in the case of a vertical screen display in the full-screen display mode, the display control section 220 causes the status information ST1 to ST4 which is displayed in the third display region D3 to be displayed separately in a plurality of regions in accordance with details of the status information ST1 to ST4. In (b) of FIG. 6, the display control section 220 (i) causes the status information ST1 to ST3 to be displayed in a region located on the right side of the notch part A1 and causes the status information ST4 to be displayed in a region located on the left side of the notch part A1.

(a) or (b) of FIG. 6 illustrates a display of the electronic device 1 in a case where the display control section 220 causes the display process to be carried out in the full-screen display mode. This is specifically described below. (a) of FIG. 6 illustrates the display of the electronic device 1 in a case where no status information ST1 to ST4 is displayed during activation of the application 310.

In a case where no status information ST1 to ST4 is displayed, the display control section 220 causes details of the application 310 to be displayed in the third display region D3. In a case where the details of the application 310 are displayed in the third display region D3, which is the entire display region of the display surface, it is possible to achieve a large display of the details of the application 310.

Meanwhile, of FIG. 6 illustrates the display of the electronic device 1 in a case where the status information ST1 to ST4 is displayed during activation of the application 310. In a case where the status information. ST1 to ST4 is displayed, the status information ST1 to ST4 is displayed. in, for example, an upper part of the third display region D3. In a part of the third display region D3 in which part no status information ST1 to ST4 is displayed, the details of the application 310 is displayed. The display control section 220 can alternatively be configured to, while causing the status information ST1 to ST4 to be displayed in the upper part of the third display region. D3, cause an operation button display DD1 to be displayed in, for example, a lower part of the third display region D3.

Even in a case where the status information ST1 to ST4, the details of the application 310, and the operation button display DD1 are displayed in the third display region D3, since the third display region D3 is the entire display region of the display surface, it is possible to achieve the following effect. That is, it is possible to obtain an effect of achieving a large display of the details of the application 310 while causing the status information ST1 to ST4 and the operation button display DD1 to be displayed.

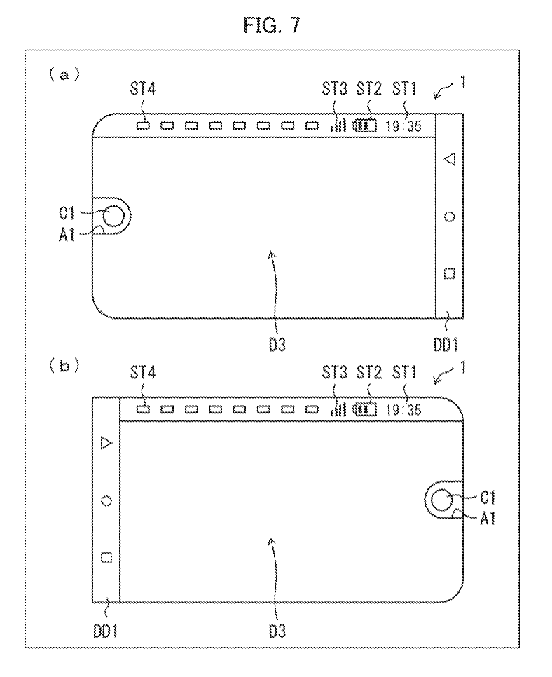

Next, the following description discusses, with reference to (a) and (b) of FIG. 7, a case where a control section 20 causes a change from the vertical screen display to a transverse screen display in the full-screen display mode. Assume that, in a state of the vertical screen display, the electronic device 1 is instructed, through the touch operation carried out by the user, to carry out the transverse screen display. In this case, an input section 110 detects a touch input carried out by the user, and then supplies, to the display control section 220, a result of the detection of the touch input.

In accordance with the result of the detection of the touch input, the display control section 220 controls a display section 120 so as to cause the change from the vertical screen display to the transverse screen display. In the case of the transverse screen display, the display control section 220 causes the status information ST1 to ST4 to be displayed in a single region without being displayed separately in a plurality of regions. (a) or (b) of FIG. 7 illustrates a display of the electronic device 1 in a case where the display control section 220 controls the display section 120 so as to cause the change from the vertical screen display to the transverse screen display.

For example, as illustrated in (a) of FIG. 7, in a case where the notch part A1 is located on the left, the display control section 220 can cause the status information ST1 to ST4 to be displayed in a side part (on an upper side) of the third display region D3. Meanwhile, as illustrated in (b) of FIG. 7, in a case where the notch part A1 is located on the right, the display control section 220 can cause the status information ST1 to ST4 to be displayed in the side part (on the upper side) of the third display region D3.

As described earlier, it is possible to display the status information ST1 to ST4 in the third display region D3, which is the entire display region of the display surface, and consequently to make the status information ST1 to ST4 easily recognizable to the user. Furthermore, in the case of the transverse screen display, the control section 20 causes the status information ST1 to ST4 to be displayed in a single region without being displayed. separately in a plurality of regions. With the configuration, the status information ST1 to ST4 is displayed in a single region in the case of the transverse screen display which allows a transversely long use of a screen of the electronic device 1, whereas the status information ST1 to ST4 is displayed separately in a plurality of regions in the case of the vertical screen display which prevents the transversely long use of the screen of the electronic device 1. This allows notification information to be suitably displayed in accordance with a length of a usable region of the screen of the electronic device 1.

[Software Implementation Example]

Control blocks of the electronic device 1 (particularly, the application executing section 210, the display control section 220, the mode determining section 230, and the control section 20 including the application executing section 210, the display control section 220, and the mode determining section 230) can be realized by a logic circuit (hardware) provided in an integrated circuit (IC chip) or the like or can be alternatively realized by software

In the latter case, the electronic device 1 includes a computer that executes instructions of a program that is software realizing the foregoing functions. The computer includes, for example, at least one processor (control device) and at least one storage medium in which the program is stored so as to be readable by the computer. An object of the present invention can be achieved in a case where the processor of the computer reads and executes the program stored in the storage medium. Examples of the processor encompass a Central Processing Unit (CPU). Examples of the storage medium encompass “a non-transitory tangible medium” such as a Read Only Memory (ROM) or the like, a tape, a disk, a card, a semiconductor memory, and a programmable logic circuit. The electronic device 1 can further include a Random Access Memory (RAM) or the like in which the program is loaded. The program can be supplied to or made available to the computer via any transmission medium (such as a communication network or a broadcast wave) which allows the program to be transmitted. Note that an aspect of the present invention can also be achieved in the form of a computer data signal in which the program is embodied via electronic transmission and which is embedded in a carrier wave.

[Recap]

An electronic device (1) in accordance with a first aspect of the present invention includes: an input section (110) configured to detect an input carried out by a user; a display section (120) at least a part of which is provided with a notch part (A1); and a control section (20), the control section providing the display section with a first display region (D1) in which the notch part is provided and a second display region (D2) which is a display region different from the first display region, the control section causing the display section to carry out a display process in at least either of the following two display modes: an enlarged display mode in which to display status information (ST1 to ST4) of the electronic device in the first display region and to use the second display region as a region in which to show details of an application; and an alternative display mode in which to display no status information of the electronic device in the first display region and to display the status information of the electronic device in the second display region, and the control section causing a switchover accepting display (SW1) for accepting a switchover from the alternative display mode to the enlarged display mode to be displayed in the first display region through the input from the input section.

With the configuration, while the status information is being displayed in the second display region, the display modes can be switched so that the status information is displayed in the first display region. This allows a change from a state in which a region in which to show details of an application or the like is made narrow due to the status information which is being displayed in the second display region to a state in which, while the status information is being displayed, the entire second display region is used as the region in which to show details of an application or the like. This brings about an effect of switching the display modes by a simple method in accordance with whether or not to display the status information.

An electronic device (1) in accordance with a second aspect of the present invention can be configured such that, in the first aspect, in a case where the status information. (ST1 to ST4) is being displayed in the alternative display mode, the control section (20) causes the switchover accepting display (SW1) to be displayed.

The configuration allows the switchover from the alternative display mode to the enlarged display mode in a case where the status information is being displayed in the alternative display mode.

An electronic device (1) in accordance with a third aspect of the present invention can be configured such that: in the first or second aspect, the display section has a display surface which is rectangular; and in the case of a vertical screen display in the enlarged display mode, the control section (20) causes the status information (ST1 to ST4) which is displayed in the first display region (D1) to be displayed separately in a plurality of regions in accordance with details of the status information (ST1 to ST4), and in the case of a transverse screen display, the control section (20) switches the enlarged display mode to the alternative display mode and causes the status information to be displayed in a single region without being displayed separately in a plurality of regions.

With the configuration, the status information is displayed in a single region in the case of the transverse screen display which allows a transversely long use of a screen of the electronic device, whereas the status information is displayed separately in a plurality of regions in the case of the vertical screen display which prevents the transversely long use of the screen of the electronic device. This allows notification information to be suitably displayed in accordance with a length of a usable region of the screen of the electronic device.

An electronic device (1) in accordance with a fourth aspect of the present invention can be configured such that, in the third aspect, in the case of the transverse screen display, the control section (20) causes nothing to be displayed in the first display region (D1).

The first display region in the transverse screen display is less easily visually recognizable to the user. Thus, even in a case where some information is displayed in the first display region, it may be impossible for the user to recognize that information. With the configuration, in the case of the transverse screen display, since nothing is displayed in the first display region, it is possible to prevent or reduce a wasteful display of information.

An electronic device (1) in accordance with a fifth aspect of the present invention can be configured such that, in any one of the first through fourth aspects, the control section (20) causes a switchover accepting display (SW2), different from the switchover accepting display (SW1), for accepting a switchover from the enlarged display mode to the alternative display mode to be displayed in the first display region (D1).

With the configuration, the display modes can be switched from the enlarged display mode to the alternative display mode. This allows the status information to be displayed in the second display region which is easily visually recognizable to the user.

A control device in accordance with a sixth aspect of the present invention includes: an input section configured to detect an input carried out by a user; a display section (120) at least a part of which is provided with a notch part (A1); a display control section (220); and a mode determining section (230), the display control section providing the display section with a first display region (D1) in which the notch part is provided and a second display region (D2) which is a display region different from the first display region, the display control section causing a display process to be carried out on a display surface of the display section in at least either of the following two display modes: an enlarged display mode in which to display status information (ST1 to ST4) of the control device in the first display region and to use the second display region as a region in which to show details of an application; and an alternative display mode in which to display no status information of the control device in the first display region and to display the status information of the control device in the second display region, the display control section causing a switchover accepting display for accepting a switchover from the alternative display mode to the enlarged display mode to be displayed in the first display region through the input from the input section, and the mode determining section determining at least either of the two display modes, which are the enlarged display mode and the alternative display mode, and then supplying a result of the determination to the display control section.

The configuration brings about working effects similar to those of the first aspect.

A method in accordance with a seventh aspect of the present invention for controlling an electronic device (1) including a display section at least a part of which is provided with a notch part (A1), the method includes; a first step of providing a display surface of the display section with a first display region (D1) in which the notch part is provided and a second display region (D2) which is a display region different from the first display region; and a second step (a step S30 or a step S40) of causing the display section to carry out a display process in at least either of the following two display modes: an enlarged display mode in which to display status information (ST1 to ST4) of the electronic device in the first display region and to use the second display region as a region in which to show details of an application; and an alternative display mode in which to display no status information of the electronic device in the first display region and to display the status information of the electronic device in the second display region, in the second step, a switchover accepting display being displayed in the first display region through an input carried out by a user, the switchover accepting display being a display for accepting a switchover from the alternative display mode to the enlarged display mode.

The configuration brings about working effects similar to those of the first aspect.

[Supplemental Remarks]

An electronic device (1) in accordance with a first variation of the present invention includes: a display section (120) at least a part of which is provided with a notch part (A1); and a control section (20), the control section providing the display section with a first display region (D1) in which the notch part is provided and a second display region (D2) which is a display region different from the first display region, and the control section causing the display section to carry out a display process in at least either of the following two display modes: an enlarged display mode in which to display status information (ST1 to ST4) of the electronic device in the first display region and to use the second display region as a region in which to show details of an application; and an alternative display mode in which to display no status information of the electronic device in the first display region.

With the configuration, the control section causes the display section to carry out the display process in either of (i) the enlarged display mode in which to display the status information in the first display region and the alternative display mode in which to display no status information in the first display region. With the configuration, in a case where the status information is displayed, the status information can be displayed in the first display region. This makes it possible to use, as a region in which to show details of an application or the like, the entire second display region which is unaffected by the notch part. Furthermore, even in a case where an application or the like that is designed to display no status information is activated, it is possible to display the status information, without reducing a region in which to show details of the application or the like, while clearly displaying an image on the display surface.

An electronic device (1) in accordance with a second variation of the present invention can be configured such that, in the first variation, in order to cause the status information (ST1 to ST4) of the electronic device to be displayed during activation of the application, the control section (20) causes the display process to be carried out in the enlarged display mode, and in order to cause no status information of the electronic device to be displayed during activation of the application, the control section (20) causes the display process to be carried out in the alternative display mode.

With the configuration, in order to cause the status information of the electronic device to be displayed during activation of the application, the control section causes the display process to be carried out in the enlarged display mode, and in order to cause no status information of the electronic device to be displayed during activation of the application, the control section causes the display process to be carried out in the alternative display mode. This makes it possible to display the status information without reducing a region in which to show details of the application.

An electronic device (1) in accordance with a third variation of the present invention can be configured such that, in the first or second variation, in order to cause the status information (ST1 to ST4) of the electronic device to be displayed while the display process is being carried out in the alternative display mode, the control section (20) causes the status information to be displayed in the second display region (D2).

With the configuration, in order to cause the status information to be displayed while the display process is being carried out in the alternative display mode, the control section causes the status information to be displayed in the second display region. This makes it possible to suitably display the status information also in the alternative display mode.

An electronic device (1) in accordance with a fourth variation of the present invention can be configured such that, in the third variation, in order to cause the status information (ST1 to ST4) to be displayed in the second display region (D2), the control section (20) causes a switchover accepting display (SW1) for accepting a switchover from the alternative display mode to the enlarged. display mode to be displayed in the first display region (D1).

With the configuration, in order to cause the status information to be displayed in the second display region, the control section causes the switchover accepting display for accepting the switchover from the alternative display mode to the enlarged display mode to be displayed in the first display region. This allows a switchover to a display of the status information in the first display region during the display of the status information in the second display region. This also allows a change from a state in which a region in which to show details of an application or the like is made narrow due to the status information which is being displayed in the second display region to a state in which, while the status information is being displayed, the entire second display region is used as the region in which to show details of an application or the like.

An electronic device (1) in accordance with a fifth variation of the present invention can be configured such that, in any one of the first through fourth variations, the control section (20) which has caused a change from a vertical screen display to a transverse screen display in the enlarged display mode switches the enlarged display mode to the alternative display mode so that the display process is carried out in the alternative display mode.

With the configuration, the control section which has caused the change from the vertical screen display to the transverse screen display in the enlarged display mode switches the enlarged display mode to the alternative display mode so that the display process is carried out in the alternative display mode. With the configuration, the display process can be carried out in the alternative display mode during the transverse screen display. This allows the status information to be displayed in the second display region, and consequently allows the status information to be easily recognizable to the user.

An electronic device (1) in accordance with a sixth variation of the present invention can be configured such that: in any one of the first through fifth variations, the display section (120) has a display surface which is rectangular; the notch part (A1) is provided on at least one side of an outer edge of the display surface; and the first display region (D1) is provided parallel to one side of the outer edge on which one side the notch part is provided.

The configuration makes it possible to set the first display region and the second display region without causing a feeling of strangeness to the user.

An electronic device (1) in accordance with a seventh variation of the present invention can be configured such that, in any one of the first through fifth variations, the outer edge of the display surface of the display section (120) has at least one corner which is arc-shaped.

With the configuration, the outer edge of the display surface of the display section has at least one corner which is arc-shaped. With the configuration, by, for example, causing the electronic device to have a frame which is fit to corners of the outer edge of the display surface, the electronic device can have a smaller frame while having a smaller size.

A control device in accordance with an eighth variation of the present invention includes: a display section (120) at least a part of which is provided with a notch part (A1); a display control section (220); and a mode determining section (230), the display control section providing the display section with a first display region (D1) in which the notch part is provided and a second display region (D2) which is a display region different from the first display region, the display control section causing the display section to carry out a display process in at least either of the following two display modes: an enlarged display mode in which to display status information (ST1 to ST4) of the control device in the first display region and to use the second display region as a region in which to show details of an application; and an alternative display mode in which to display no status information of the control device in the first display region, and the mode determining section determining at least either of the two display modes, which are the enlarged display mode and the alternative display mode, and then supplying a result of the determination to the display control section.

The configuration brings about working effects similar to those of the first variation.

A method in accordance with a ninth variation of the present invention for controlling an electronic device (1) including a display section (120) at least a part of which is provided with a notch part (A1), the method includes: providing the display section with a first display region (D1) in which the notch part is provided and a second display region (D2) which is a display region different from the first display region; and causing the display section to carry out a display process in at least either of the following two display modes: an enlarged display mode in which to display status information (ST1 to ST4) of the electronic device in the first display region and to use the second display region as a region in which to show details of an application; and an alternative display mode in which to display no status information of the electronic device in the first display region (a step S30 or a step S40).

The configuration brings about working effects similar to those of the first variation.

An electronic device 1 in accordance with the foregoing aspects of the present invention may be realized by a computer. In this case, the present invention encompasses: a control program for the electronic device 1 which program causes a computer to operate as the foregoing sections (software elements) of the electronic device 1 so that the electronic device 1 can be realized by the computer; and a computer-readable storage medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 Electronic device

10 Touch panel

20 Control section

30 Storage section

110 Input section

120 Display section

210 Application executing section

220 Display control section

230 Mode determining section

310 Application

320, ST1-ST4 Status information

330 Mode information

A1 Notch part

C1 Camera

D1. First display region

D2 Second display region

D3 Third display region

DD1 Operation button display

SW1, SW2 Switchover accepting display

1. An electronic device comprising:
an input section configured to detect an input carried out by a user;
a display section at least a part of which is provided with a notch part; and
a control section,
the control section providing the display section with a first display region in which the notch part is provided and a second display region which is a display region different from the first display region,
the control section causing the display section to carry out a display process in at least either of the following two display modes: an enlarged display mode in which to display status information of the electronic device in the first display region and to use the second display region as a region in which to show details of an application; and an alternative display mode in which to display no status information of the electronic device in the first display region and to display the status information of the electronic device in the second display region, and
the control section causing a first switchover accepting display for accepting a switchover from the alternative display mode to the enlarged display mode to be displayed in the first display region through the input from the input section.

2. The electronic device as set forth in claim 1, wherein, in a case where the status information is being displayed in the alternative display mode, the control section causes the first switchover accepting display to be displayed.

3. The electronic device as set forth in claim 1, wherein:
the display section has a display surface which is rectangular; and
in the case of a vertical screen display in the enlarged display mode, the control section causes the status information which is displayed in the first display region to be displayed separately in a plurality of regions in accordance with details of the status information, and in the case of a transverse screen display, the control section switches the enlarged display mode to the alternative display mode and causes the status information to be displayed in a single region without being displayed separately in a plurality of regions.

4. The electronic device as set forth in claim 3, wherein in the case of the transverse screen display, the control section causes nothing to be displayed in the first display region.

5. The electronic device as set forth in claim 1, wherein the control section causes a second switchover accepting display, different from the first switchover accepting display, for accepting a switchover from the enlarged display mode to the alternative display mode to be displayed in the first display region.

6. A control device comprising:
an input section configured to detect an input carried. out by a user;
a display section at least a part of which is provided with a notch part;
a display control section; and
a mode determining section,
the display control section providing the display section with a first display region in which the notch part is provided and a second display region which is a display region different from the first display region,
the display control section causing a display process to be carried out on a display surface of the display section in at least either of the following two display modes: an enlarged display mode in which to display status information of the control device in the first display region and to use the second display region as a region in which to show details of an application; and an alternative display mode in which to display no status information of the control device in the first display region and to display the status information of the control device in the second display region,
the display control section causing a switchover accepting display for accepting a switchover from the alternative display mode to the enlarged display mode to be displayed in the first display region through the input from the input section, and
the mode determining section determining at least either of the two display modes, which are the enlarged display mode and the alternative display mode, and then supplying a result of the determination to the display control section.

7. A method for controlling an electronic device including a display section at least a part of which is provided with a notch part,
said method comprising:
a first step of providing a display surface of the display section with a first display region in which the notch part is provided and a second display region which is a display region different from the first display region; and
a second step of causing the display section to carry out a display process in at least either of the following two display modes: an enlarged display mode in which to display status information of the electronic device in the first display region and to use the second display region as a region in which to show details of an application; and an alternative display mode in which to display no status information of the electronic device in the first display region and to display the status information of the electronic device in the second. display region,
in the second step, a switchover accepting display being displayed in the first display region through an input carried out by a user, the switchover accepting display being a display for accepting a switchover from the alternative display mode to the enlarged display mode.
